(19) United States
(12) Patent Application Publication
(10) Pub. No.: US 2016/0251013 A1
(43) Pub. Date: Sep. 1, 2016

(54) METHOD FOR CARRYING OUT AN ENGINE FUNCTION IN AN INTERNAL COMBUSTION ENGINE

(71) Applicant: Robert Bosch GmbH, Stuttgart (DE)

(72) Inventors: Benoit Budiscak, Hohenhaslach (DE); Ronald Remy, Ludwigsburg (DE)

(21) Appl. No.: 15/051,140

(22) Filed: Feb. 23, 2016

(30) Foreign Application Priority Data
Feb. 26, 2015 (DE) 102015203467.4

(51) Int. Cl. B60W 20/40; B60W 30/18; B60W 50/06; B60W 10/06; B60W 10/08; B60W 50/02; B60W 20/50; B60W 20/16

(52) U.S. Cl. CPC B60W 20/40; B60W 20/50; B60W 30/18072; B60W 20/16; B60W 10/06; B60W 10/08; B60W 50/0205; B60W 50/06; B60W 2050/0014

(57) ABSTRACT

A method for carrying out an engine function in an internal combustion engine having an electric machine coupled thereto, a run-down time of the internal combustion engine being prolonged by a time duration by the electric machine, through the outputting of a torque, during a shutting off of the internal combustion engine, and the engine function being carried out during the run-down time.

### CROSS REFERENCE

The present application claims the benefit under 35 U.S.C. §119 of German Patent Application No. 102015203467.4 filed on Feb. 26, 2015, which is expressly incorporated herein by reference in its entirety.

### FIELD

The present invention relates to a method for carrying out an engine function, such as a learning, correction, or diagnostic function, in an internal combustion engine.

### BACKGROUND INFORMATION

Motor vehicles, and in particular their internal combustion engines, have components that have certain tolerances as a result of their manufacture. Deviations or drift in such components can occur for example even during the lifespan of the motor vehicle or of the internal combustion engine. Causes of this include for example wear, contamination, and the like.

In order to compensate these deviations within manufacturing tolerances, and to correct the drift within the lifespan, so-called learning or correction functions can be used. These functions correct, for example, engine controlling parameters, so that the internal combustion engine behaves as in nominal operation. That is, an internal combustion engine that has components having certain tolerances or aged components, should, as a result of the learning or correction functions, show the same behavior, in particular with regard to output, exhaust gas emissions, and the like, as an internal combustion engine having nominal components, i.e., having ideal components without tolerance.

In addition, legislation requires that certain components and functions be monitored and diagnosed by the engine controlling. This is done by so-called onboard diagnostic, or OBD, systems. The OBD functions report that a component may possibly be defective, for example via an error entry in the error memory, and, if warranted, also through a warning in a display instrument (for example using a so-called malfunction indicator light, or MIL light, or some other service light).

However, many diagnostic or learning functions require for their execution a large amount of time and/or particular operating conditions that may occur only rarely, as a function of a driving profile or of the use of the motor vehicle or of a machine. Here it can be difficult to find a time period for carrying out the respective function during which its execution will remain unnoticed by the driver, and in which the conditions for the execution are optimal. Therefore, the motor vehicle, or the internal combustion engine, is often in a non-optimal state for a longer period of time, i.e., a state in which for example not all the learning functions have yet been trained.

Moreover, the OBD requirements are becoming more and more numerous and strict. In parallel, exhaust gas norms are becoming stricter, and require that the correction functions be carried out regularly and reliably. Many such functions require a coasting phase of the internal combustion engine, i.e., a phase without injection, in order to be able to be carried out.

For many applications, such as stationary engines for off-highway applications (cooling aggregates, block heating installations, current generators, baggers, front loaders, etc.) there are for the most part no, or almost no, coast phases. Coast phases also occur rarely in motor vehicles having automatic transmission. The design of diagnostic and learning functions for an exhaust gas cycle is therefore correspondingly complicated.

German Patent Application No. DE 10 2013 201 257 A1 describes, for example, a method in which the engine rotational speed is increased before switching off the engine, so that the coast phase when the engine is shut off is prolonged, and a calibration of the lambda sensor is thus facilitated.

An increase in the engine rotational speed however has a strange effect for the user, usually a driver, and in addition causes higher fuel consumption.

It is therefore desirable to indicate a possibility for an energy-friendly and user-friendly execution of engine functions in an internal combustion engine.

### SUMMARY

According to the present invention, an example method is described for carrying out an engine function in an internal combustion engine. Advantageous embodiments are described below.

An example method according to the present invention is used to carry out an engine function in an internal combustion engine having an electric machine coupled thereto. Here, when the internal combustion engine is shut off, a run-down time of the internal combustion engine is prolonged for a time duration by the electric machine through the outputting of a torque, and the engine function is carried out during the run-down time. In order to prolong the run-down time, for example a crankshaft of the internal combustion engine to which the electric machine is coupled can be loaded with the torque by the machine.

While during the method mentioned above the rotational speed of the internal combustion engine is increased when shut off, in order in this way to increase the run-down time and thus the coasting phase of the internal combustion engine, the present invention makes use of the fact that in modern internal combustion engines an electric machine that can be driven by an engine is in most cases additionally already coupled on. Using this electric machine, the run-down time of the internal combustion engine can be prolonged without additional fuel consumption. During a stop phase, the ignition is indeed normally off; however, the engine control device is still running, i.e., the control device still has current. This offers a very good possibility for carrying out such functions. Moreover, a user or driver will hardly perceive continued running with, for example, a rotational speed that at first remains the same, or will perceive it as far less disturbing than an increase in the rotational speed of the internal combustion engine at a time at which the engine is actually to be shut off. In particular in the case of passenger vehicles, which today mostly make use of a so-called start-stop system, in this way, a large number of coast phases of the internal combustion engine can be produced very quickly during which an engine function can be carried out. Likewise, however, in this way, an efficient coast phase can also be achieved when the internal combustion engine is shut off in internal combustion engines in other applications having coupled electric machines, such as the off-highway applications mentioned above. Overall, a significantly faster training of functions or sensors, such as a lambda sensor, is also for example achieved in this way.

Advantageously, the engine function includes a function that requires a coast phase of the internal combustion engine. Due to the simple possibility of producing coast phases when the internal combustion engine is shut off using the electric machine, such functions can be carried out particularly frequently. Such functions can, for example, include a lambda sensor calibration or a diagnosis for a hot air mass sensor.

Preferably, the engine function includes a learning function, a correction function, or a diagnostic function. In particular, it is useful if the engine function is carried out by a control device, for example during operation of an associated motor vehicle. Learning and correction functions in particular, but also diagnostic functions, are important in order to set the internal combustion engine into an optimal operating state, so that the exhaust gas values and fuel consumption are always optimal, and in order to recognize possible errors. If the execution of the functions through the use of the stop phases takes place more frequently and faster, then the internal combustion engine is more quickly, or more frequently, in an optimal operating state. For the diagnostic functions, in particular functions of an onboard diagnosis (OBD) are also relevant. An ever more frequent monitoring of the functioning of the internal combustion engine in the context of the OBD is necessary precisely with regard to stricter emissions limits that have to be maintained.

Advantageously, the time duration by which the run-down time of the internal combustion engine is prolonged is selected as a function of the engine function that is to be carried out. Various functions standardly require different lengths of time for their execution. The time duration by which the run-down time of the internal combustion engine is prolonged can be chosen correspondingly. In this way, the shortest possible run-down time can always be used, which, for example, contributes to saving energy.

It may be advantageous if a rotational speed curve during the run-down time is chosen as a function of the engine function that is to be carried out. In this way an optimal adaptation to the engine function to be carried out is possible. For example, the rotational speed can at first be held approximately constant, and then brought down. For particular engine functions, it can for example also make sense to first increase the rotational speed, i.e., to accelerate the internal combustion engine using the electric machine.

Preferably, before shutting off the internal combustion engine it can be decided, on the basis of stored and/or collected data, whether the run-down time is prolonged during the shutoff and the engine function is carried out. In this way, for example a regular execution of particular engine functions can be achieved. An unnecessary prolongation of the run-down time is thus not necessary.

Advantageously, it can be decided, on the basis of stored and/or collected data, which engine function will be carried out during the next shutting off of the internal combustion engine with prolonged run-down time. In this way, it can be ensured that necessary engine functions are carried out regularly. This makes sense and is helpful in particular in the case of diagnostic functions such as OBD functions.

It may advantageous if the stored and/or collected data include information concerning engine functions that can be carried out, the number and/or times of engine functions carried out, and/or a prioritization of the engine functions. For example, these data can be provided in a memory of a control device. Via the number and times of the execution, regularity of the execution can be ensured, while various functions can be differentiated by prioritizing them according to their importance. Thus, for example, certain diagnostic functions relating to maintaining emissions limits may be more important than certain learning or correction functions.

Preferably, the prolongation of the run-down time is made perceptible optically and/or acoustically, in particular if the time duration by which the run-down time of the internal combustion engine is prolonged exceeds a prespecified threshold value. It is true that a prolongation of the run-down time of the internal combustion engine using an electric machine is significantly less noticeable or disturbing for a user or driver than, for example, a deliberate increase in the rotational speed, but an indication thereof provides assurance to the driver or user. This holds in particular the longer the time duration of the prolongation is, and/or if the internal combustion engine is, exceptionally, to be accelerated. Here it can also be useful to display or communicate a remaining runtime.

A computing device according to the present invention, e.g., a control device, in particular an engine control device of an internal combustion engine, is set up, in particular in terms of programming, to carry out an example method according to the present invention.

The implementation of the example method in the form of software is also advantageous because this results in particularly low costs, in particular if an executing control device is also used for further tasks and is therefore already present. Suitable data carriers for providing the computer program are in particular diskettes, hard drives, flash memories, EEPROMs, CD-ROMs, DVDs, and others. A downloading of a program via computer networks (Internet, intranet, etc.) is also possible.

Further advantages and embodiments of the present invention are described below and are shown in the figures.

It will be understood that the features described above and explained below may be used not only in the respectively indicated combination, but also in other combinations, or by themselves, without departing from the scope of the present invention.

The present invention is shown schematically on the basis of an exemplary embodiment in the figures, and is described in the following with reference to the figures.

### BRIEF DESCRIPTION OF THE DRAWINGS

FIG. 1 schematically shows an internal combustion engine having an electric machine coupled thereto, with which the example method according to the present invention can be carried out.

FIG. 2 shows a rotational speed curve of an internal combustion engine during the carrying out of a method according to the present invention in a preferred specific embodiment.

FIG. 3 shows, in a flow diagram, a sequence of a method according to the present invention in a preferred specific embodiment.

### DETAILED DESCRIPTION OF EXAMPLE EMBODIMENTS

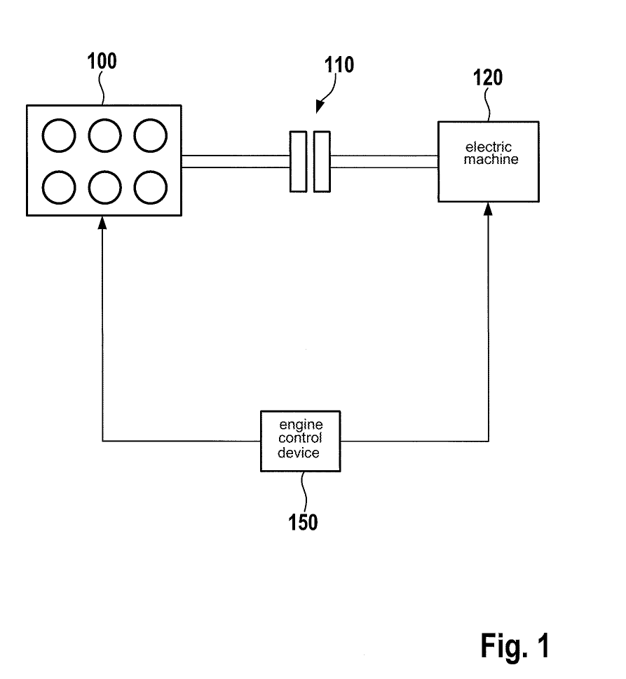

In FIG. 1, an internal combustion engine 100 is shown schematically and in simplified form, which is coupled to an electric machine 120 via a coupling 110 as an example. With this system, a method according to the present invention can be carried out.

Internal combustion engine 100 can be for example a gasoline engine or diesel engine. However, it can also be an internal combustion engine for the burning of gas such as natural gas. Electric machine 120 can be for example an electric motor as used for hybrid drive systems. These also include for example so-called mild hybrids having less powerful electric motors, or vehicles having recuperation machines or starter generators. The coupling between internal combustion engine 100 and electric machine 120 can also be realized differently, for example by a belt drive or a direct connection.

In addition, a computing unit realized as an engine control device 150 is also shown, provided as an example both for the controlling of internal combustion engine 100 and for the controlling of electric machine 120.

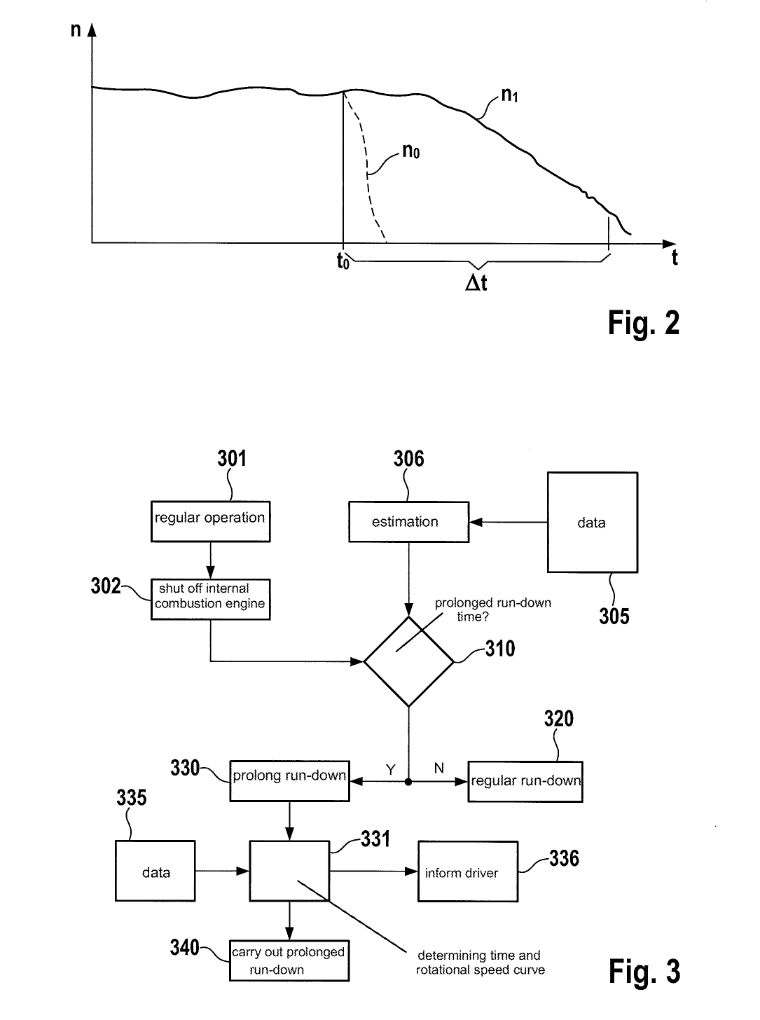

FIG. 2 shows a rotational speed curve of an internal combustion engine, such as internal combustion engine 100, during execution of a method according to the present invention in a preferred specific embodiment. For this purpose, rotational speed n is plotted over time t.

Up to time t0, the internal combustion engine runs for example in no-load operation. At time t0, the internal combustion engine is shut off, for example by a start-stop system, or by shutting off the ignition. In the regular case, i.e., without application of a method according to the present invention, the rotational speed would now fall to zero relatively quickly, as shown by rotational speed curve n0.

With the application of a method according to the present invention, in contrast, the rotational speed is first held approximately constant by the electric machine, and is then brought down slowly, as illustrated by rotational speed curve n1.

Here, the run-down time of the internal combustion engine is prolonged by the time duration Δt. During this prolonged run-down time, in particular after an end of the injection up to shortly before standstill has been reached, the internal combustion engine is in a coast phase, in which an engine function can be carried out.

Here, a rotational speed monitoring is taken over by the electric machine. The rotational speed shape is here a function of the requirements of the engine function that is to be carried out. For example, the engine function can be a calibration of a lambda sensor, in which as much fresh air as possible is required in the exhaust gas tract of the internal combustion engine. For this purpose, the rotational speed is usefully first held approximately at the no-load operation level by the electric machine, and only after this is brought slowly to zero.

The driver or user of the vehicle or of the machine is, if warranted, here informed that the engine stop will take longer than usual. As needed, the electric machine can also accelerate the internal combustion engine in the stop phase if a higher rotational speed is required, for example in order to produce more air mass. In this case, the driver or user should be informed that this course of action is unusual.

FIG. 3 shows, in a flow diagram, an example of a sequence of a method according to the present invention in a preferred specific embodiment. Starting from regular operation of the internal combustion engine in step 301, in step 302 the internal combustion engine is shut off.

In a step 310, for example during the shutting off or shortly before it, it is decided whether there is a need for a prolongation of the run-down time of the internal combustion engine. For this purpose, in step 306 an estimation is made of the need for a prolongation, which for example is in turn based on various information from error memories, or other collected and/or stored data that were collected in step 305.

If, in step 310, it is decided that there is no need for a prolongation of the run-down time, then a regular run-down of the internal combustion engine takes place according to step 320. If, however, it is decided that there is a need for a prolongation of the run-down time, then a prolongation of the run-down takes place in accordance with step 330.

In a step 331, the time duration by which the run-down is prolonged, and the rotational speed curve during the prolonged run-down, are now determined. For this purpose, for example data for the engine function to be carried out are accessed according to step 335, which data are stored for example in a memory of an engine control device.

Finally, in a step 340 the engine function is carried out during a suitably prolonged run-down of the internal combustion engine. Optionally, for example as a function of the engine function to be carried out, of the length of the time duration by which the run-down time has been prolonged, and/or of the rotational speed curve during the run-down, a driver or user can be informed in a step 336 about the impending prolongation of the run-down. This can take place for example via a display in an instrument panel, and/or acoustically.

What is claimed is:

1. A method for carrying out an engine function in an internal combustion engine having an electric machine coupled thereto, the method comprising:
prolonging a run-down time of the internal combustion engine by a time duration through the outputting of a torque by the electric machine during a shutting off of the internal combustion engine; and
carrying out the engine function during the run-down time.

2. The method as recited in claim 1, wherein the engine function includes a function that requires a coast phase of the internal combustion engine.

3. The method as recited in claim 1, wherein the engine function includes one of: a learning function, a correction function, or a diagnostic function.

4. The method as recited in claim 1, wherein the engine function is carried out by a control device.

5. The method as recited in claim 1, wherein the time duration by which the run-down time of the internal combustion engine is prolonged is selected as a function of the engine function that is to be carried out.

6. The method as recited in claim 1, wherein a rotational speed curve during the run-down time is selected as a function of the engine function that is to be carried out.

7. The method as recited in claim 1, further comprising:
before a shutting off the internal combustion engine, based on at least one of stored and collected data, deciding whether the run-down time during the shutoff is prolonged and the engine function is carried out.

8. The method as recited in claim 1, further comprising:
based on at least one of stored and collected data, deciding which engine function is carried out during a next shutting off of the internal combustion engine with prolonged run-down time.

9. The method as recited in claim 6, wherein the at least one of the stored and collected data includes information concerning at least one of: i) engine functions that can be carried out, ii) the number or times of engine functions carried out, and iii) a prioritization of the engine functions.

10. The method as recited in claim 1, wherein the prolongation of the run-down time is made at least one of optically and acoustically perceptible if the time duration by which the run-down time of the internal combustion engine is prolonged exceeds a prespecified threshold value.

11. A computing unit configured to:
prolong a run-down time of the internal combustion engine by a time duration through the outputting of a torque by the electric machine during a shutting off of the internal combustion engine; and
carry out the engine function during the run-down time.

12. A machine-readable storage medium storing a computer program, the computer program, when excited by a computing unit, causing the computing unit to perform:
prolonging a run-down time of the internal combustion engine by a time duration through the outputting of a torque by the electric machine during a shutting off of the internal combustion engine; and
carrying out the engine function during the run-down time.
